(19) United States
(12) Patent Application Publication
(10) Pub. No.: US 2025/0284630 A1
(43) Pub. Date: Sep. 11, 2025

(54) MULTIMODE SOLID-STATE DRIVE WITH ADAPTIVE ADDRESS MAPPING TABLE COMPACTION

(71) Applicant: ScaleFlux, Inc., San Jose, CA (US)

(72) Inventors: Tong Zhang, Albany, NY (US); Jiangpeng Li, San Jose, CA (US); Ganesh Venkatakrishnan, Milpitas, CA (US); Yang Liu, Milpitas, CA (US); Fei Sun, Irvine, CA (US)

(21) Appl. No.: 18/595,694

(22) Filed: Mar. 5, 2024

(51) Int. Cl. G06F 12/02

(52) U.S. Cl. CPC G06F 12/0246; G06F 2212/7201; G06F 2212/7205

(57) ABSTRACT

A method for optimizing sub-table usage in a multimode solid-state drive having a plurality of flash memory chips addressable via PBAs and a controller chip that utilizes a set of mapping tables to map LBAs to PBAs and wherein each mapping table is partitioned into a set of sub-tables. In one approach, sub-tables are optimized during a garbage collection (GC) that includes: selecting a group of memory blocks and identifying valid LBAs of still-valid data in the memory blocks; sorting the valid LBAs to identify groups of consecutive LBAs; storing data associated with each group of consecutive LBAs to an associated group of consecutive PBAs during a GC copy operation; updating associated sub-tables, wherein only a first PBA of each group of consecutive PBAs is stored in the associated sub-table; and updating a metadata block for each associated sub-table to identify un-stored PBAs in the associated sub-table.

### TECHNICAL FIELD

The present invention relates to the field of solid-state drives (SSD), and particularly to SSDs that more effectively serve applications that demand different I/O block sizes.

### BACKGROUND

Solid-state drives (SSDs), which use non-volatile NAND flash memory technology, are being pervasively deployed in numerous computing and storage systems. In addition to one or multiple NAND flash memory chips, each SSD must contain a controller chip that manages all the NAND flash memory chips. Within each NAND flash memory chip, all the memory cells are organized in an “array→block→page” hierarchy, where one NAND flash memory array consists of a large number (e.g., thousands) of blocks, and each block contains a certain number of pages (e.g., 256). The size of each flash memory page typically ranges from 8KiB to 32KiB, and the size of each flash memory block is typically tens of megabytes (MBs). Data are programmed in the unit of flash memory pages. NAND flash memory cells must be erased before being re-programmed, and the erase operation is carried out in the unit of blocks (i.e., all the pages within the same block must be erased at the same time). As a result, SSDs do not support in-place data update and hence must perform out-of-place data update, i.e., when the host updates/writes data, SSDs cannot directly over-write old data with the new data at the same NAND flash memory physical page location, instead SSDs must write the new data to another NAND flash memory physical page and mark the old data as invalid.

To support out-of-place data update on NAND flash memory, SSDs must internally implement an indirect data address mapping: SSDs internally manage data on NAND flash memory pages in the unit of physical data blocks. Each physical data block is assigned with one unique physical block address (PBA). Instead of directly exposing PBAs to the host, SSDs expose an array of logical block address (LBA) and internally manage/maintain the mapping between LBA and PBA. The software component responsible for managing the LBA-PBA mapping is called the flash translation layer (FTL). Since NAND flash memory does not support in-place data update, writes to one LBA will trigger a change of the LBA-PBA mapping (i.e., the same LBA is mapped with another PBA to which the new data are physically written). To ensure high-speed operation, SSDs typically integrate DRAM to keep the entire LBA-PBA FTL mapping table. Given the total NAND flash memory storage capacity, the FTL map table size reduces as the PBA block size increases. Hence, to reduce the intra-SSD DRAM cost overhead, modern SSDs use the PBA block size of 4096 B and map one or multiple consecutive LBAs onto one PBA.

### SUMMARY

Aspects of this disclosure provide a system, method and program product for implementing multimode SDDs with optimized mapping tables.

A first aspect of the disclosure provides a multimode solid-state drive (SSD), comprising: a plurality of flash memory chips addressable via physical block addresses (PBAs); and a controller chip that utilizes a set of mapping tables to map logical block addresses (LBAs) to PBAs, wherein each mapping table is configured for a different LBA block size and each is partitioned into a set of sub-tables, and wherein sub-table sizes are optimized during a garbage collection (GC) process that includes: selecting a group of memory blocks and identifying valid LBAs of still-valid data in the memory blocks; sorting the valid LBAs to identify groups of consecutive LBAs; storing data associated with each group of consecutive LBAs to an associated group of consecutive PBAs during a GC copy operation; updating associated sub-tables, wherein only a first PBA of each group of consecutive PBAs is stored in the associated sub-table; and updating a metadata block for each associated sub-table to identify un-stored PBAs in the associated sub-table.

A second aspect of the disclosure provides a method for optimizing sub-table sizes during a garbage collection (GC) process in a multimode solid-state drive (SSD) having a plurality of flash memory chips addressable via physical block addresses (PBA) and a controller chip that utilizes a set of mapping tables to map logical block addresses (LBAs) to PBAs and wherein each mapping table is partitioned into a set of sub-tables, comprising: selecting a group of memory blocks and identifying valid LBAs of still-valid data in the memory blocks; sorting the valid LBAs to identify groups of consecutive LBAs; storing data associated with each group of consecutive LBAs to an associated group of consecutive PBAs during a GC copy operation; updating associated sub-tables, wherein only a first PBA of each group of consecutive PBAs is stored in the associated sub-table; and updating a metadata block for each associated sub-table to identify un-stored PBAs in the associated sub-table.

A third aspect of the disclosure provides multimode solid-state drive (SSD), comprising: a plurality of flash memory chips addressable via physical block addresses (PBAs); and a controller chip configured to map logical block addresses (LBAs) received from a host to PBAs according to a mapping table stored in DRAM, wherein the mapping tables include a set of sub-tables that map different LBA block sizes according to a process that includes: configuring each sub-table to map an LBA segment of 2^{d} consecutive LBAs to 2^{d} consecutive PBAs, where d is a selectable integer value to achieve different compaction formats for different sub-tables; and storing only a first PBA of the 2^{d} consecutive PBAs in the associated sub-table.

A fourth aspect of the invention provides method for implementing a multimode solid-state drive (SSD) having a plurality of flash memory chips addressable via physical block addresses (PBA) and a controller chip configured to map logical block addresses (LBAs) received from a host to PBAs according to a mapping table stored in DRAM, wherein the mapping table includes a set of sub-tables that map different LBA block sizes according to process that includes: configuring each sub-table to map an LBA segment of 2^{d} consecutive LBAs to 2^{d} consecutive PBAs, where d is a selectable integer value to achieve different compaction formats for different sub-tables; and storing only a first PBA of the 2^{d} consecutive PBAs in the associated sub-table.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 depicts an SSD memory system, in accordance with an illustrative embodiment.

FIG. 2 depicts an LBA partitioning, in accordance with an illustrative embodiment.

FIG. 3 illustrates the partitioning of the FTL LBA-PBA mapping table into an array of sub-tables, in accordance with an illustrative embodiment.

FIG. 4 illustrates the method of reducing sub-table size by dynamically removing consecutive PBAs from the mapping sub-tables, in accordance with an illustrative embodiment.

FIG. 5 depicts the operational flow diagram of proposed garbage collection process that could improve the effectiveness of the first design technique, in accordance with an illustrative embodiment.

FIG. 6 depicts the operational flow diagram of serving a read request when using the first design technique, in accordance with an illustrative embodiment.

FIG. 7 depicts the operational flow diagram of serving a write request when using the first design technique, in accordance with an illustrative embodiment.

FIG. 8 depicts the second design technique that enforces compaction format onto one or multiple sub-tables, in accordance with an illustrative embodiment.

FIG. 9 depicts the addition of an unaligned write request cache into SSD controller in support of the second design technique, in accordance with an illustrative embodiment.

FIG. 10 depicts a write request that partially overlaps with LBA segments of sub-tables when using the second design technique, in accordance with an illustrative embodiment.

FIG. 11 depicts the operational flow diagram when unaligned write request cache becomes full, in accordance with an illustrative embodiment.

FIG. 12 depicts the operational flow diagram of serving a read request when using the second design technique, in accordance with an illustrative embodiment.

FIG. 13 depicts the operational flow diagram of serving a write request when using the second design technique, in accordance with an illustrative embodiment.

The drawings are intended to depict only typical aspects of the disclosure, and therefore should not be considered as limiting the scope of the disclosure.

### DETAILED DESCRIPTION OF THE DISCLOSURE

Embodiments of the disclosure provide technical solutions for an SSD infrastructure that more effectively serves applications that demand different I/O block sizes. Recent years have witnessed the significant growth of high-value artificial intelligence (AI) oriented applications that involve a huge amount of active working data set (e.g., hundreds of GiB and multiple TBs) and are meanwhile dominated by moderate-size data access (e.g., 256 B or 512 B per data access). For such applications, a hybrid-DRAM/SSD memory hierarchy can be much more cost-effective than a DRAM-only memory hierarchy. However, with the limited DRAM capacity for an FTL mapping table, modern SSDs cannot well serve moderate-size data access for those applications. Aspects of this disclosure provide systems and methods for enabling SSDs to more effectively serve moderate-size data access at minimal implementation complexity and cost overhead.

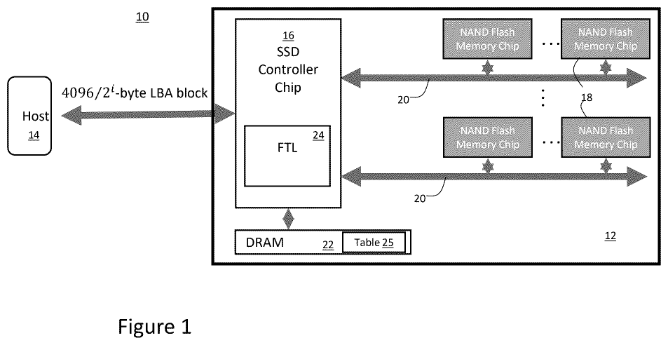

FIG. 1 illustrates an SSD architecture 10 that generally includes a multimode SSD 12 coupled to a host 14. In this embodiment, SSD 12 includes a controller chip 16, multiple NAND flash memory chips 18 organized over multiple channels 20, and one (or a few) DRAM chips 22. The NAND flash memory storage space is partitioned into physical data blocks, each one is assigned with a unique physical block address (PBA).

In the SSD architecture 10 (SSDs), the SSDs expose an array of logical block addresses (LBAs), each one associates with Nᵢ=4096/2ⁱ bytes of storage space. For example, when i is 0 or 3, each LBA will associate with N₀=4096 bytes or N₃=512 bytes. The value of i is determined when SSDs are being formatted by the host 14. Since NAND flash memory does not support in-place data update, SSDs internally implement a flash translation layer (FTL) 24 to dynamically map the host-visible LBA space onto the host-oblivious PBA space inside SSDs. To ensure high speed performance, the FTL mapping table 25 must entirely reside on the DRAM 22 inside SSDs. Since the FTL mapping table entries are sorted by LBAs and hence each FTL mapping table entry only needs to contain one PBA, the FTL mapping table size reduces as the PBA block size increases. To reduce the DRAM usage, modern SSDs typically set the PBA block size as 4096 bytes (plus error correction coding (ECC) redundancy). Hence, with the LBA block size of Nᵢ=4096/2ⁱ bytes, FTL 24 must maintain a mapping table that maps 2 consecutive LBAs onto one 4096-byte PBA.

As noted, AI-oriented applications involve a huge amount of active working data set (e.g., hundreds of GBs and multiple TBs) and meanwhile are dominated by moderate-size data access (e.g., 256 B or 512 B per data access). For such applications, storing their huge amount of active working data set over a hybrid-DRAM/SSD memory hierarchy can be much more cost-effective than using a DRAM-only memory hierarchy. SSD I/O interface protocols (e.g., NVMe) allow the host 14 to partition/format SSDs so that different partitions have different LBA block sizes (e.g., 512 B or 4096 B).

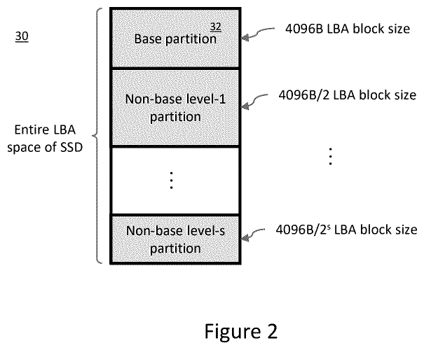

FIG. 2 depicts an illustrative partitioning 30. As illustrated, to fully utilize the SSD interface I/O bandwidth, the host 14 should partition one SSD into multiple partitions, in which each partition has a distinct LBA block size of Nᵢ=4096/2ⁱ bytes. The base level-0 partition 32 has an LBA block size of 4096 B (i.e., i=0) and provides general-purpose data storage as ordinary SSDs. With less-than-4096 B LBA block size, the other non-base level-i partitions can better serve applications that can benefit from less-than-4096 B I/O block size (e.g., 256 B or 512 B per I/O block data access).

Inside such multimode SSDs with different LBA block sizes, an FTL 24 manages the LBA-PBA mapping for all the partitions. To support random writes over non-base partitions, SSDs may match the PBA block size to LBA block size, e.g., for the non-base level-i partition with the LBA block size of Nᵢ=4096/2ⁱ bytes, its associated PBA block size is also Nᵢ=4096/2ⁱ bytes. However, a smaller PBA block size directly leads to a larger number of FTL mapping table entries and hence a larger FTL mapping table size, leading to a higher DRAM usage.

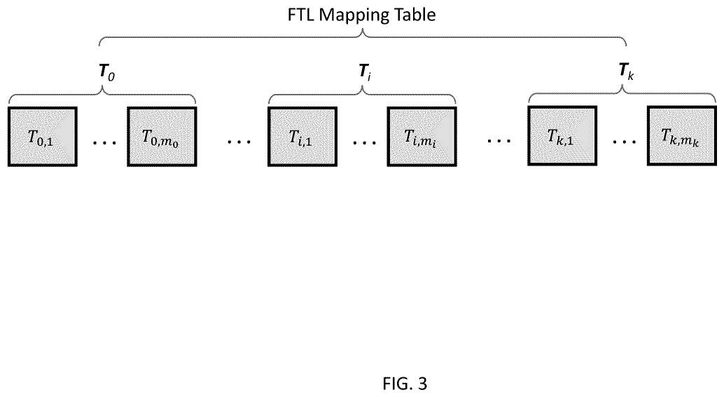

Various solutions are presented to reduce the DRAM (dynamic random-access memory) usage overhead for the envisioned multimode SSDs. As shown in FIG. 3, for a multimode SSD with the minimal permissible LBA block size of 4096/2^{k}, its FTL 25 maintains k+1 separate mapping tables, each one Tᵢ for the partition with the LBA block size 4096/2ⁱ for 0≤i≤k. If the SSD does not have partition with the LBA block size of 4096/2^{d} (d∈[0, k]), then the table T_{d} is simple empty. Suppose the partition with the LBA block size 4096/2ⁱ covers total M consecutive LBAs, given a design parameter hᵢ, the mapping table Tᵢ is further partitioned into Mᵢ/hᵢ sub-tables, where each sub-table T_{i,j} covers hᵢ consecutive LBAs. Each sub-table T_{i,j} is stored in DRAM separately from other sub-tables. Various techniques are provided to reduce the size of one or multiple sub-tables T_{i,j}'s.

### Technique I

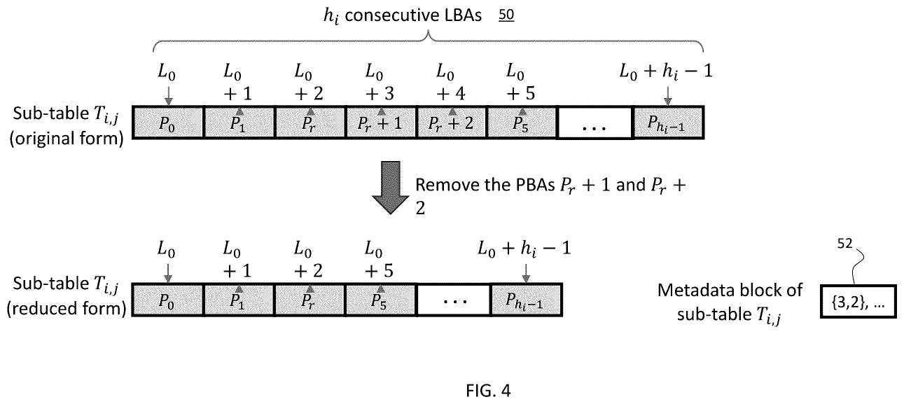

The first technique is described as follows. As shown in FIG. 4, in the original form of one sub-table T_{i,j}, there are hᵢ table entries. Let L₀ denote the first LBA in the sub-table T_{i,j}, all the mapping table entries correspond to the LBA of L₀, L₀+1, L₀+2, . . . , L₀+hᵢ−1. The sub-table T_{i,j} stores all the hᵢ PBAs that map to the hᵢ consecutive LBAs 50. If multiple consecutive LBAs map to consecutive PBAs, FTL 24 will only keep the first PBA of the group of consecutive PBAs in the sub-table T_{i,j} and prune the rest of consecutive PBAs from the sub-table T_{i,j}. For example, as shown in FIG. 4, the three LBAs {L₀+2, L₀+3, L₀+4} map to three consecutive PBAs {Pᵣ, Pᵣ+1, Pᵣ+2}, the sub-table will keep only the PBA Pᵣ and remove the subsequent two consecutive PBAs {Pᵣ+1, Pᵣ+2}, leading to a smaller sub-table size (shown at the bottom of FIG. 4). Meanwhile, for each sub-table in which one or more PBAs have been removed, FTL 24 maintains a separate metadata block 52 to record the location and length of each group of consecutive PBAs that have been removed. As shown in FIG. 4, for the PBAs {Pᵣ+1, Pᵣ+2} that have been removed from the sub-table, the corresponding metadata block 52 contains a pair {3, 2}, where the first element “3” means that the first removed PBA corresponds to the 3^{rd} entry in the sub-table, and the second element “2” means that total 2 consecutive PBAs have been removed from the sub-table.

The effectiveness of this technique on reducing sub-table size essentially depends on the number of consecutive PBAs that store consecutive LBAs and hence can be removed from sub-tables. To improve the effectiveness of this technique, the following process may be applied. First, let's quickly review the process of SSD garbage collection (GC). Due to the absence of in-place update support of NAND flash memory, SSDs serve write requests by storing to-be-written data to new flash memory locations and marking the old version of data on NAND flash memory as invalid. Over time, NAND flash memory will contain more and more invalid data. To reclaim the storage capacity occupied by those invalid data, SSDs must periodically carry out background GC operations. Since NAND flash memory cells must undergo erase operations before storing new data and the erase operation is performed in the unit of physical flash memory blocks (typical physical flash memory block size is a few GBs), SSDs carry out GC operation over a group of physical flash memory blocks: Given a group (e.g., 16) of physical flash memory blocks to be processed by GC, we first copy all the still-valid data from these physical flash memory blocks to one or few other recently-erased physical flash memory blocks. As a result, all the data in the group of physical flash memory blocks can be considered invalid, and these physical flash memory blocks can be safely erased.

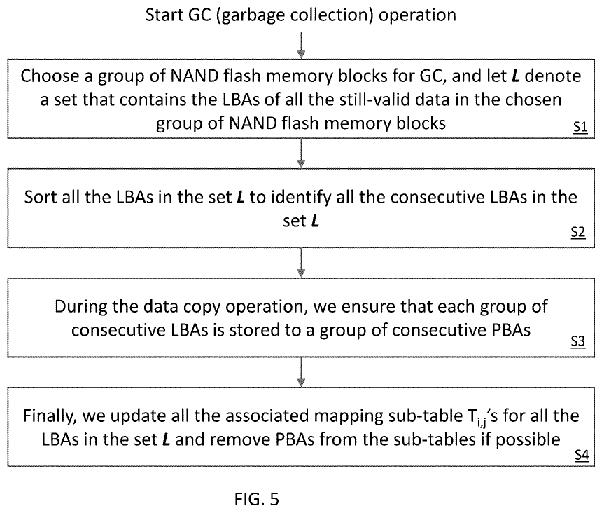

The GC operations can be utilized to implement the proposed first technique as shown in FIG. 5. During the GC operation, at S1, a group of memory blocks are chosen, and let L denote a set that contains the LBAs of all the still-valid data in the to-be-erased group of physical flash memory blocks. At S2, before copying the content of all the LBAs in the set L to new locations, we first sort all the LBAs in the set L to identify all the consecutive LBAs in the set L. At S3, during the data copy operation, we ensure that each group of consecutive LBAs is stored to a group of consecutive PBAs. This will help to create more occurrences of consecutive LBAs mapping to consecutive PBAs, which will enable SSD to remove more PBAs from the mapping sub-tables. Finally, at S4, we update all the associated mapping sub-table T_{i,j}'s for all the LBAs in the set L and remove PBAs from the sub-tables if possible.

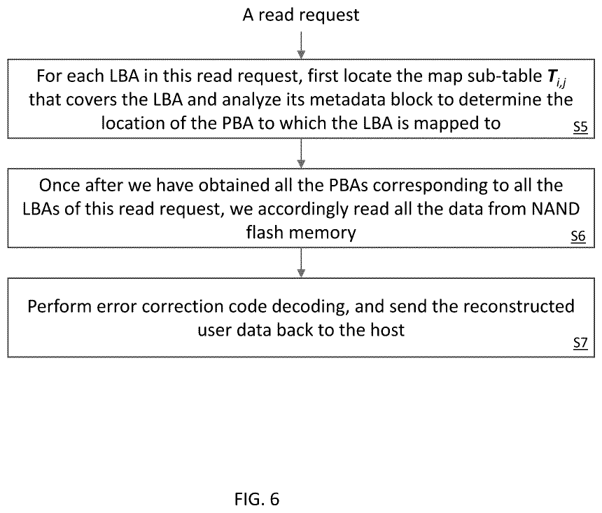

FIG. 6 shows the operational flow diagram of serving a read request: Upon receiving a read request that covers one or multiple consecutive LBAs, at S5, for each LBA, we first locate the map sub-table T_{i,j} that covers the LBA and analyze its metadata block to determine the location of the PBA to which the LBA is mapped to. At S6, after we have obtained all the PBAs corresponding to all the LBAs of this read request, we accordingly read all the data from NAND flash memory, and at S7 perform error correction code decoding, and send the reconstructed user data back to the host.

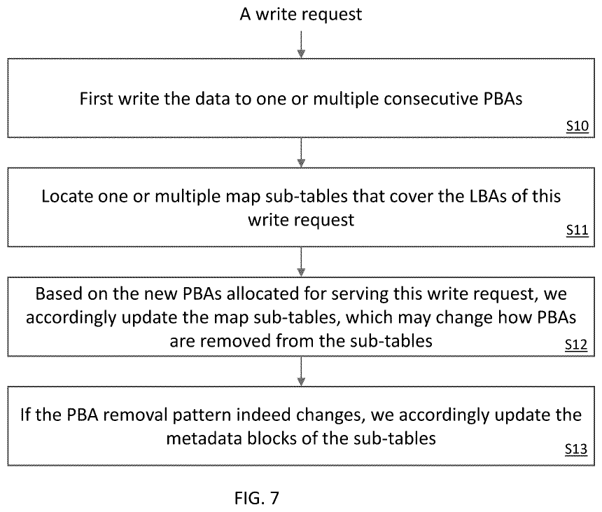

FIG. 7 shows the operational flow diagram of serving a write request: Upon receiving a write request that covers one or multiple consecutive LBAs, at S10, we first write the data to one or multiple consecutive PBAs. Meanwhile, at S11, we locate one or multiple map sub-tables that cover the LBAs of this write request. At S12, based on the new PBAs allocated for serving this write request, we accordingly update the map sub-tables, which may change how PBAs are removed from the sub-tables. At S13, if the PBA removal pattern indeed changes, we accordingly update the metadata blocks of the sub-tables.

### Technique II

The above presented first technique reduces the size of one or multiple sub-tables by dynamically removing some PBA entries and using additional metadata blocks to record the PBA removals. In comparison, the second technique reduces the size of one or more sub-tables by uniformly removing PBA entries without employing additional metadata blocks. For a partition with the LBA data block size of 4096/2ⁱ, its PBA block size equals to the LBA block size (i.e., 4096/2ⁱ). As discussed above, given a design parameter hᵢ, the mapping table Tᵢ of this partition is further partitioned into Mᵢ/hᵢ sub-tables, where each sub-table T_{i,j} covers hᵢ consecutive LBAs. In its baseline format, each sub-table T_{i,j}, contains hᵢ PBAs, each PBA has the block size of 4096/2ⁱ and maps to one LBA.

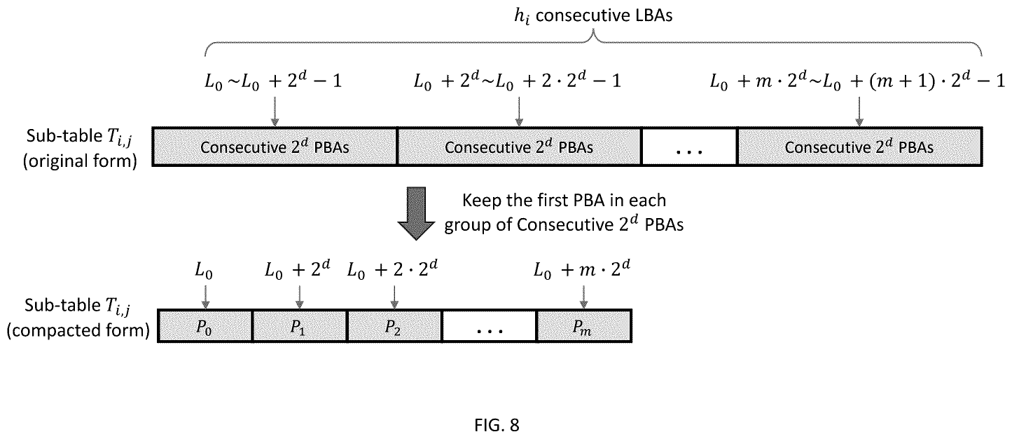

In this approach, to reduce the sub-table size, as shown in FIG. 8, we enforce a rule in which each group of 2^{d} consecutive LBAs maps to 2^{d} consecutive PBAs (assume hᵢ is divisible by 2^{d} and

$$m = \frac{{h}_{i}}{{2}^{d}} ) ,$$

hence the sub-table only needs to store the first PBA of each group of 2^{d} consecutive PBAs, leading to the sub-table size reduction of 2^{d}×. This is referred to as mapping table compaction. Each group of consecutive 2^{d} consecutive LBAs is called an LBA segment, and one LBA segment maps to one PBA segment that contains the group of 2^{d} consecutive PBAs.

By limiting the value of d∈[0, v], each sub-table can have v+1 different possible storage compaction formats denoted as f₀, f₁, . . . , fᵥ. With the storage compaction format fₜ, the sub-table maps 2^{t} consecutive LBAs to 2^{t} consecutive PBAs, leading to the sub-table size reduction of 2^{t}×. Subject to the total DRAM capacity, the SSD FTL 25 can adjust the storage compaction format of all the sub-tables across all the partitions in adaptation to the runtime data write characteristics. Let R_{i,j} denote the LBA range of the sub-table T_{i,j}. SSD FTL 25 should use the storage compaction format fₙ with the largest possible n so that (almost) all the write requests over the LBA range R_{i,j} do not partially overlap with any LBA segment that contains a group of 2^{d} consecutive LBAs.

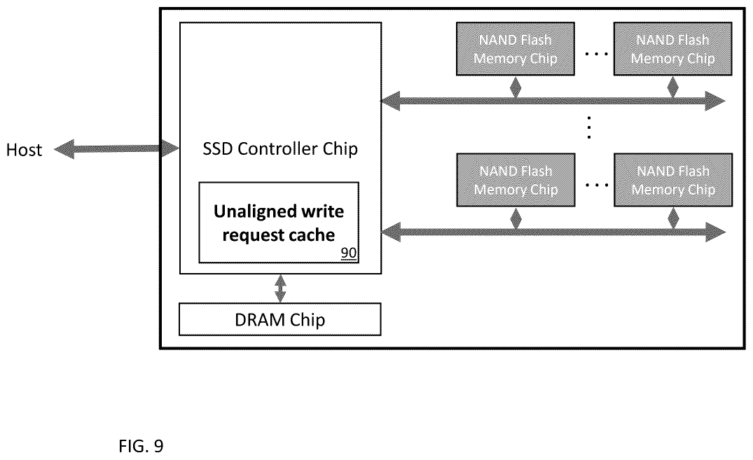

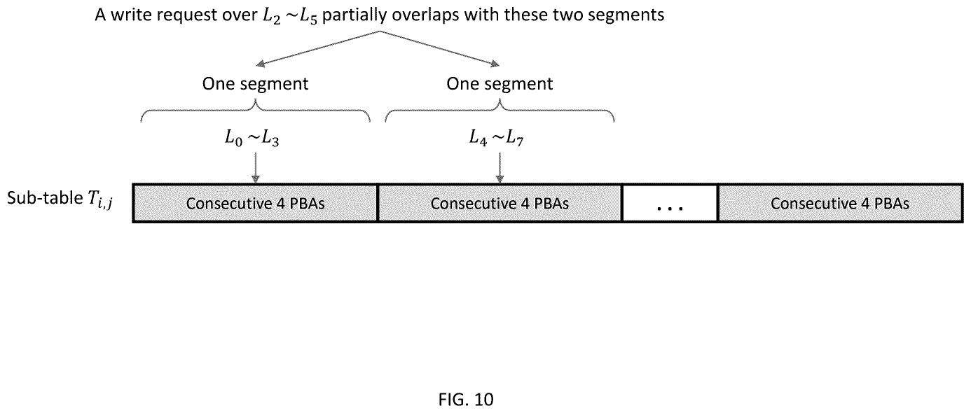

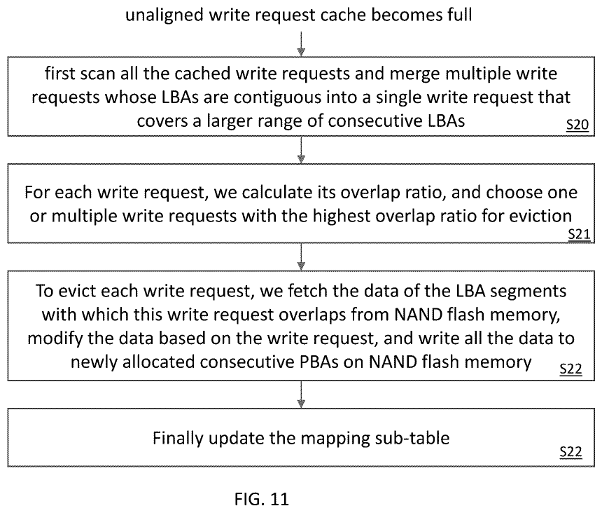

To facilitate the runtime adjustment of storage compaction format over all the sub-tables, as shown in FIG. 9, SSD controller chip integrates an unaligned write request cache 90 that temporarily caches the unaligned write requests that partially overlap with one or multiple LBA segments. For example, as shown in FIG. 10, for a sub-table in which each LBA segment covers 4 consecutive LBAs, if a write request partially overlaps with one LBA segment, this write request will be placed into the unaligned write request cache 90. When the unaligned write request cache 90 becomes full, the SSD controller chip evicts one or multiple cached write requests using the operational flow diagram as shown in FIG. 11: We first scan all the cached write requests and merge multiple write requests whose LBAs are contiguous into a single write request that covers a larger range of consecutive LBAs at S20. For each write request, at S21, we calculate its overlap ratio as follows: Assume this write request writes data to S_{w} consecutive LBAs, and this write request partially overlaps with one or multiple LBA segments covering total Sₒ (Sₒ>S_{w}) consecutive LBAs. We define the overlap ratio as S_{w}/Sₒ. We choose one or multiple write requests with the highest overlap ratio and evict them from the unaligned write request cache 90 to NAND flash memory. At S22, to evict each write request from unaligned write request cache 90 to NAND flash memory, we fetch the data of the LBA segments with which this write request overlaps from NAND flash memory, modify the data based on the write request, and write all the data to newly allocated consecutive PBAs on NAND flash memory, and finally update the sub-table at S22.

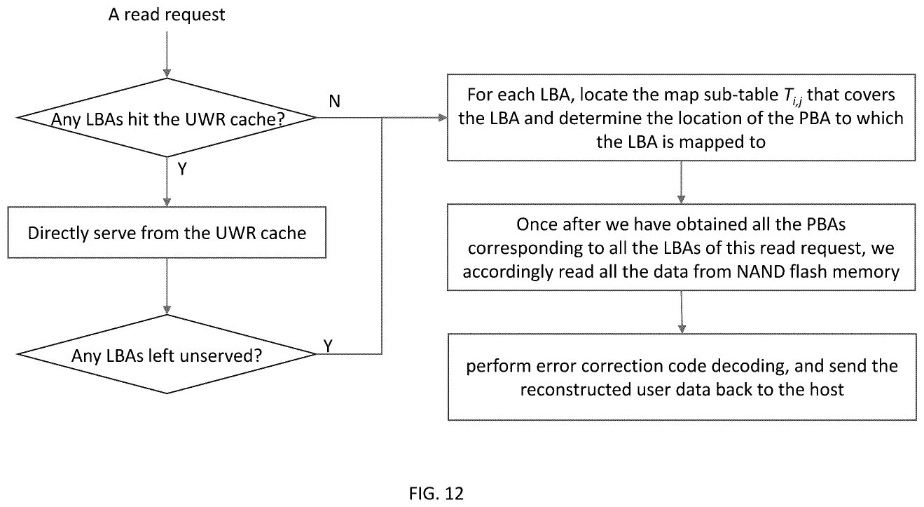

FIG. 12 shows the operational flow diagram of serving a read request: Upon receiving a read request that covers one or multiple consecutive LBAs, for each LBA, we first check whether the unaligned write request cache (UWR cache) holds the data. If yes, then we directly serve the read request from the unaligned write request cache, otherwise we will perform the following operations: First locate the map sub-table T_{i,j} that covers the LBA and determine the location of the PBA to which the LBA is mapped to. Once after we have obtained all the PBAs corresponding to all the LBAs of this read request, we accordingly read all the data from NAND flash memory, perform error correction code decoding, and send the reconstructed user data back to the host.

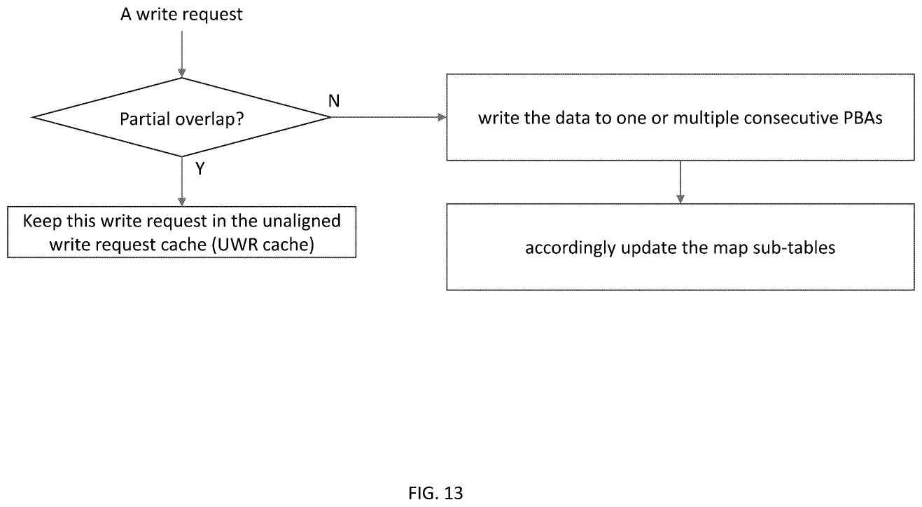

FIG. 13 shows the operational flow diagram of serving a write request: Upon receiving a write request that covers one or multiple consecutive LBAs, if this write request partially overlaps with LBA segments in one or multiple sub-tables, we will keep this write request in the unaligned write request cache 90. Otherwise, we write the data to one or multiple consecutive PBAs, and accordingly update the map sub-tables.

It is understood that aspects of the present disclosure may be implemented in any manner, e.g., as a software/firmware program, an integrated circuit board, a controller card, etc., that includes a processing core, I/O, memory and processing logic. Aspects may be implemented in hardware or software, or a combination thereof. For example, aspects of the processing logic may be implemented using field programmable gate arrays (FPGAs), application specific integrated circuit (ASIC) devices, and/or other hardware-oriented systems.

Aspects also may be implemented with a computer program product stored on a computer readable storage medium. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random-access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, etc. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Python, Smalltalk, C++ or the like, and conventional procedural programming languages, such as the “C” programming language or similar programming languages. The computer readable program instructions may execute entirely on a host computer, partly on a host computer, on a remote computing device (e.g., a memory card) or entirely on the remote computing device. In the latter scenario, the remote computing device may be connected to the host computer through any type of interface or network. In some embodiments, electronic circuitry including, for example, programmable logic circuitry, field-programmable gate arrays (FPGA), or programmable logic arrays (PLA) may execute the computer readable program instructions by utilizing state information of the computer readable program instructions to control electronic circuitry in order to perform aspects of the present disclosure.

Computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. The computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by hardware and/or computer readable program instructions.

The flowcharts and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The foregoing description of various aspects of the present disclosure has been presented for purposes of illustration and description. It is not intended to be exhaustive or to limit the concepts disclosed herein to the precise form disclosed, and obviously, many modifications and variations are possible. Such modifications and variations that may be apparent to an individual in the art are included within the scope of the present disclosure as defined by the accompanying claims.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A multimode solid-state drive (SSD), comprising:
a plurality of flash memory chips addressable via physical block addresses (PBAs); and
a controller chip that utilizes a set of mapping tables to map logical block addresses (LBAs) to PBAs, wherein each mapping table is configured for a different LBA block size and each is partitioned into a set of sub-tables, and wherein sub-table sizes are optimized during a garbage collection (GC) process that includes:
selecting a group of memory blocks and identifying valid LBAs of still-valid data in the memory blocks;
sorting the valid LBAs to identify groups of consecutive LBAs;
storing data associated with each group of consecutive LBAs to an associated group of consecutive PBAs during a GC copy operation;
updating associated sub-tables, wherein only a first PBA of each group of consecutive PBAs is stored in the associated sub-table; and
updating a metadata block for each associated sub-table to identify un-stored PBAs in the associated sub-table.

2. The multimode SSD of claim 1, wherein updating associated sub-tables includes:
initially storing in the associated sub-table all of the PBAs in the group of consecutive PBAs; and
removing all of the PBAs in the group of consecutive PBAs from the associated sub-table, except for the first PBA.

3. The multimode SSD of claim 1, wherein updating the metadata block includes entering a data pair {x, y} where x refers to a first un-stored PBA and y refers to a number of un-stored PBAs.

4. The multimode SSD of claim 1, wherein the controller chip performs a read request from a host according to a process that includes:
for each LBA in the read request, locate the associated sub-table and analyze an associated metadata block to determine a corresponding PBA;
read data from memory for each corresponding PBA; and
perform error correction code (ECC) decoding and send data to the host.

5. The multimode SSD of claim 1, wherein the controller chip performs a write request from a host according to a process that includes:
write data to at least one set of consecutive PBAs;
locate at least one sub-table corresponding to LBAs of the write request;
update the at least one sub-table; and
update the associated metadata blocks of the at least one sub-table if a PBA removal pattern is changed.

6. A method for optimizing sub-table sizes during a garbage collection (GC) process in a multimode solid-state drive (SSD) having a plurality of flash memory chips addressable via physical block addresses (PBA) and a controller chip that utilizes a set of mapping tables to map logical block addresses (LBAs) to PBAs and wherein each mapping table is partitioned into a set of sub-tables, comprising:
selecting a group of memory blocks and identifying valid LBAs of still-valid data in the memory blocks;
sorting the valid LBAs to identify groups of consecutive LBAs;
storing data associated with each group of consecutive LBAs to an associated group of consecutive PBAs during a GC copy operation;
updating associated sub-tables, wherein only a first PBA of each group of consecutive PBAs is stored in the associated sub-table; and
updating a metadata block for each associated sub-table to identify un-stored PBAs in the associated sub-table.

7. The method of claim 6, wherein updating associated sub-tables includes:
initially storing in the associated sub-table all of the PBAs in the group of consecutive PBAs; and
removing all of the PBAs in the group of consecutive PBAs from the associated sub-table, except for the first PBA.

8. The method of claim 6, wherein updating the metadata block includes entering a data pair {x, y} where x refers to a first un-stored PBA and y refers to a number of un-stored PBAs.

9. The method of claim 6, wherein the controller chip performs a read request from a host according to a process that includes:
for each LBA in the read request, locate the associated sub-table and analyze an associated metadata block to determine a corresponding PBA;
read data from memory for each corresponding PBA; and
perform error correction code (ECC) decoding and send data to the host.

10. The method of claim 6, wherein the controller chip performs a write request from a host according to a process that includes:
write data to at least one set of consecutive PBAs;
locate at least one sub-table corresponding to LBAs of the write request;
update the at least one sub-table; and
update the associated metadata blocks of the at least one sub-table if a PBA removal pattern is changed.

11. A multimode solid-state drive (SSD), comprising:
a plurality of flash memory chips addressable via physical block addresses (PBAs); and
a controller chip configured to map logical block addresses (LBAs) received from a host to PBAs according to a mapping table stored in DRAM, wherein the mapping tables include a set of sub-tables that map different LBA block sizes according to a process that includes:
configuring each sub-table to map an LBA segment of 2^{d} consecutive LBAs to 2^{d} consecutive PBAs, where d is a selectable integer value to achieve different compaction formats for different sub-tables; and
storing only a first PBA of the 2^{d} consecutive PBAs in the associated sub-table.

12. The multimode SSD of claim 11, wherein the different compaction formats are adjustable to adapt to runtime data write characteristics.

13. The multimode SSD of claim 12, wherein the controller chip includes an unaligned write request cache that temporarily caches unaligned write requests that partially overlap with one or more LBA segments.

14. The multimode SSD of claim 13, wherein unaligned write request cache is managed according to a process that includes:
when the unaligned write request cache is full, scan all cached write requests and merge multiple write requests whose LBAs are contiguous into a combined write request that covers a larger range of consecutive LBAs;
for each write request, calculate an overlap ratio; and
evict the write request to memory with the highest overlap ratio, wherein evicting the write request includes fetching data of the LBA segments with which the write request overlaps from memory, modifying the data based on the write request, writing the data to newly allocated consecutive PBAs in memory, and updating the associated sub-table.

15. The multimode SSD of claim 14, wherein the controller chip performs a read request for data from a host according to a process that includes:
determining whether the unaligned write request cache holds the data and if so, serving the data from the unaligned write request cache;
in response to the unaligned write request cache not holding the data, locate a target sub-table that covers each LBA for the data and determine the location of associated PBAs to which each LBA is mapped;
read data from memory; and
perform error correction coding (ECC) and return the data to the host.

16. The multimode SSD of claim 14, wherein the controller chip performs a write request of data from a host according to a process that includes:
if the write request partially overlaps with LBA segments in one or more sub-tables, store the write request in the unaligned write request cache; and
if the write request does not partially overlap with LBA segments in one or more sub-tables, write the data to one or more consecutive PBAs, and update associated sub-tables.

17. A method for implementing a multimode solid-state drive (SSD) having a plurality of flash memory chips addressable via physical block addresses (PBA) and a controller chip configured to map logical block addresses (LBAs) received from a host to PBAs according to a mapping table stored in DRAM, wherein the mapping table includes a set of sub-tables that map different LBA block sizes according to process that includes:
configuring each sub-table to map an LBA segment of 2^{d} consecutive LBAs to 2^{d} consecutive PBAs, where d is a selectable integer value to achieve different compaction formats for different sub-tables; and
storing only a first PBA of the 2^{d} consecutive PBAs in the associated sub-table.

18. The method of claim 17, wherein the different compaction formats are adjustable to adapt to runtime data write characteristics.

19. The method of claim 18, wherein the controller chip includes an unaligned write request cache that temporarily caches unaligned write requests that partially overlap with one or more LBA segments.

20. The method of claim 19, wherein the unaligned write request cache is managed according to a process that includes:
when the unaligned write request cache is full, scan all cached write requests and merge multiple write requests whose LBAs are contiguous into a combined write request that covers a larger range of consecutive LBAs;
for each write request, calculate an overlap ratio; and
evict the write request to memory with the highest overlap ratio, wherein evicting the write request includes fetching data of the LBA segments with which the write request overlaps from memory, modifying the data based on the write request, writing the data to newly allocated consecutive PBAs in memory, and updating the associated sub-table.
